(19) United States
(12) Patent Application Publication
(10) Pub. No.: US 2026/0352587 A1
(43) Pub. Date: Nov. 5, 2026

(54) METHOD AND SYSTEM FOR FAIL-SAFE DISTRIBUTED MODELING AND APPLICATION THEREOF

(71) Applicant: Verizon Patent and Licensing Inc., Basking Ridge, NJ (US)

(72) Inventors: Praveenkumar Chandrasekaran, Chennai (IN); Chandnika R, Chennai (IN)

(73) Assignee: Verizon Patent and Licensing Inc., Basking Ridge, NJ (US)

(21) Appl. No.: 19/197,059

(22) Filed: May 2, 2025

(51) Int. Cl. H04L 43/50

(52) U.S. Cl. CPC H04L 43/50

(57) ABSTRACT

The present teaching is for predicting target network metrics. Data groups and features thereof are created based on historical data characterizing previous network operations. Each data group is modeled via machine learning based on data and features associated therewith. If the modeling is not successful and the data group is overlapping, an approximation model is created via bottom-up hierarchical approximation. If the failed data group is non-overlapping, a learned model for a successfully modeled data group is identified as its approximate model. When real-time data is received from the network, network metrics are predicted using successful models or approximate models based on needs for managing the network operation.

### BACKGROUND

In network management, different aspects of the network performance may be separately characterized. For example, a network operator may desire to balance the traffic across various regional area networks (RANs) to achieve the overall performance of the entire network. To facilitate preemptive network management, the traffic pattern of each RAN may be individually modeled so that the upcoming traffic volume associated with the RAN may be predicted to accordingly adopt preemptive measures to direct traffic across different RANs to achieve balanced overall network performance. As another example, metrics representing the health of different network components may be individually modeled so that predictions on their respective health situations may be made to facilitate preventative measures to avoid failures/problems.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for fail-safe distributed modeling, in accordance with an embodiment of the present teaching;

FIG. 1B is a flowchart of an exemplary process for fail-safe distributed modeling, in accordance with an embodiment of the present teaching;

FIG. 2A depicts an exemplary architecture of an application of fail-safe distributed modeling in network operation management, in accordance with an embodiment of the present teaching;

FIG. 2B illustrates exemplary types of network management tasks that can achieve enhanced distributed modeling via fail-safe distributed modeling, according to an embodiment of the present teaching;

FIG. 2C illustrates exemplary grouping criteria for creating different groups of data for distributed modeling;

FIG. 2D shows an exemplary data organization in which data groups established based on grouping criteria with data in each group characterized by multiple features;

FIG. 3A depicts an exemplary high-level system diagram of an alternative modeling unit, in accordance with an embodiment of the present teaching;

FIG. 3B is a flowchart of an exemplary process for an alternative modeling unit, in accordance with an embodiment of the present teaching;

FIG. 4A illustrates an example of a hierarchy of data groups relevant to a failed and overlapping data group to facilitate the identification of an alternative data grouping that allows a successful modeling, in accordance with an embodiment of the present teaching;

FIG. 4B shows exemplary means for identifying a data group with a similar feature distribution to obtain an alternative model for a failed and non-overlapping data group, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Digital data representing operational states of network elements/services/products is widely used to train models to learn the characteristics of the operation of the elements/services/products and enable their operational enhancement. Operation may include different aspects, so it is common to develop distributed models, each of which may be trained to learn the characteristics of a corresponding aspect of the operation and to be used to enhance the management of that aspect of the operation associated with the elements/service/product. In this case, data collected from the operation of the service/product may be divided into different data groups, each of which may be associated with a certain aspect of the elements/service/product and may be used to train a distributed model specifically directed to each aspect. In such distributed modeling, each data group may be typically modeled independently.

In practice, modeling of some data groups may fail for various reasons. For example, data groups that fall below a minimum size threshold may lack an adequate data volume for model training. As another example, data in some groups may exhibit low target variance (e.g., targets have substantially the same value), making it challenging to train a model due to limited information diversity. Although some simplistic “fail-safe” strategies have been employed to remedy these situations, such as assigning a uniform value to impacted data groups may be employed, these solutions are often inadequate and ineffective because they may exclude sparse yet important information, which may represent a high importance value to the element/service/product. However, the simplistically simulated model lacks the nuance of recognizing true behavior and therefore cannot be used for decision making.

The present teaching discloses an improved technique for network enhancement based on a framework for fail-safe distributed modeling via an efficient and robust systematic approach to ensure successful modeling for each individual data group in a tiered process. Each data group may first be modeled, and an assessment is made in terms of whether the modeling is successful. For each of the data groups for which modeling has failed, the group is classified into overlapping or non-overlapping classes. An overlapping data group is defined as one that is derived with respect to grouping criteria that some other data groups also share. For example, a failed data group of size one may be identified using various grouping criteria (e.g., channel, customer type, fulfillment type, and installation type), and there are other data groups identified using some of these grouping criteria, e.g., channel and customer type. On the other hand, non-overlapping data groups are identified using distinct grouping criteria. Depending on the classification of overlapping or non-overlapping, the present teaching discloses a systematic scheme to remedy each initial failed data group to obtain a successful model therefor.

To achieve fail-safe modeling for an overlapping data group, a bottom-up hierarchical approximation is employed by leveraging the grouping criteria overlapped with other data groups. In the bottom-up hierarchical approximation, the approximation starts from a bottom level with a minimum number of grouping criteria applied to obtain a data group. At the bottom level, modeling is performed with respect to the data group obtained at that level and it is determined whether the modeling at that level is successful, i.e., the models created produce satisfactory predictions. If so, approximation at the next level using more grouping criteria to obtain an updated data group at the next level and modeling is performed with respect to the updated data group. This hierarchical process continues until the modeling fails at the n^{th} level of the hierarchy yet the modeling at prior levels is successful. In this case, the model information from the previous level is used for approximation, i.e., the model at the previous level is used to approximate the model of the data group at the n^{th} level.

A data group is identified using certain grouping criteria, while each sample in a data group may be characterized based on a set of features (e.g., transmission bandwidth, capacity, error rate, etc.). Based on the feature values of each sample in a data group, a feature distribution associated with the data group may be obtained. To achieve fail-safe modeling for a non-overlapping data group, a similarity assessment mechanism is used to identify other data groups that have been successfully modeled and with feature distributions that match that of the failed non-overlapping data group. A best matching successfully modeled data group may be selected so that the model of the selected data group may be used as an approximation model for the failed non-overlapping data group. The similarity between the feature distribution of the failed data group and that of another successfully modeled data group may be evaluated based on different means, such as a Kullback-Leibler (KL) divergence test, a K-nearest neighbor test, or a test based on the Euclidian distance between the centroids of the two feature distributions.

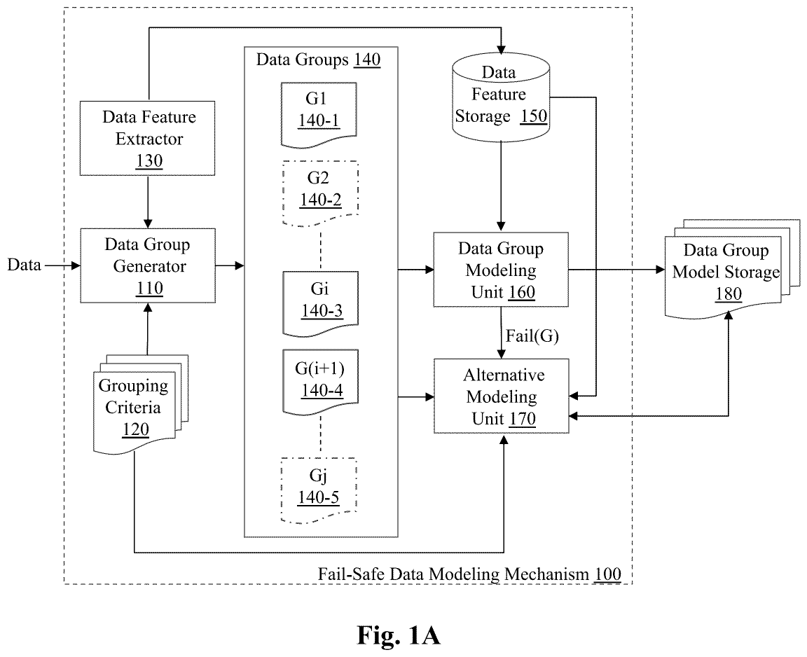

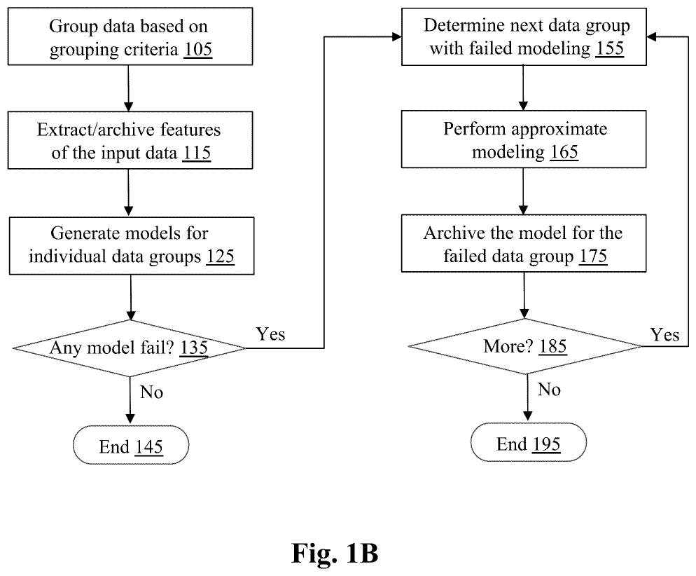

FIG. 1A depicts an exemplary framework for fail-safe distributed data modeling, in accordance with an embodiment of the present teaching. In this exemplary framework, a fail-safe data modeling mechanism 100 takes data as input and outputs data group models 180 by creating data groups based on given grouping criteria and perform fail-safe modeling of each of the data groups. In this embodiment, the fail-safe data modeling mechanism 100 comprises a data group generator 110, a data feature extractor 130, a data group modeling unit 160, and an alternative modeling unit 170. The data group generator 110 is provided for creating, based on some predetermined grouping criteria 120, data groups 140, e.g., data group G1 140-1, G2 140-2, . . . , Gi 140-3, Gi+1 140-4, . . . , and Gj 140-4. The grouping criteria 120 may be specified in each application based on the needs. For example, for an application related to managing a telecommunication network, the grouping criteria may include region, tower, channel, installation type, fulfillment type, etc. Data collection during network operation may be grouped in accordance with these specified grouping criteria.

Each sample data in a data group in 140 may also be associated with some features characterizing the sample. For example, each data sample corresponding to a tower in a network operating in a service coverage region may include information associated with its operational status, e.g., transmission speed, capacity, memory usage level, etc. Such features may be included in the received data and may be extracted by the data feature extractor 130. Such extracted features associated with samples in each data group may be stored in a data feature storage 150.

The data group modeling unit 160 is provided for modeling each of the data groups 140 and outputs data group models in data group model storage 180 for data groups that are successfully modeled (e.g., data groups 140-1, . . . , 140-3, . . . , 140-4, represented in solid shape). When some data groups fail to be successfully modeled (e.g., data groups 140-2, . . . , 140-5, represented in dotted shape), the alternative modeling unit 170 is provided for carrying out fail-safe modeling via the approximation approach as discussed herein to generate models for these failed data groups. The models for the failed data groups are also saved in storage 180 so that for each data group in 140, there is a model created in storage 180, either via the data group modeling unit 160 or via the alternative modeling unit 170.

FIG. 1B is a flowchart of an exemplary process for fail-safe distributed modeling, in accordance with an embodiment of the present teaching. In operation, when data is received, the data group generator 110 groups the input data, at 105, to generate data groups 140 based on specified grouping criteria 120. For each data sample, the data feature extractor 130 extracts, at 115, features and archive them in data feature storage 150. For each of the data groups in 140, the data group modeling unit 160 operates to generate models, at 125, for individual data groups and store the same in storage 180. If all data groups are successfully modeled, i.e., no failed modeling, determined at 135, the distributed modeling process ends at 145.

If modeling fails for some of the data groups, the process proceeds to obtain approximation models for the failed data groups. For a failed data group, determined at 155, the alternative modeling unit 170 performs, at 165, approximate modeling and then archive, at 175, the derived alternative model for the failed data group. If there is additional failed data group, determined at 185, the process proceeds to step 155 to continue the approximation modeling for the next failed data group. This process ends at 195 until all failed data groups are modeled using the approximated modeling according to the present teaching.

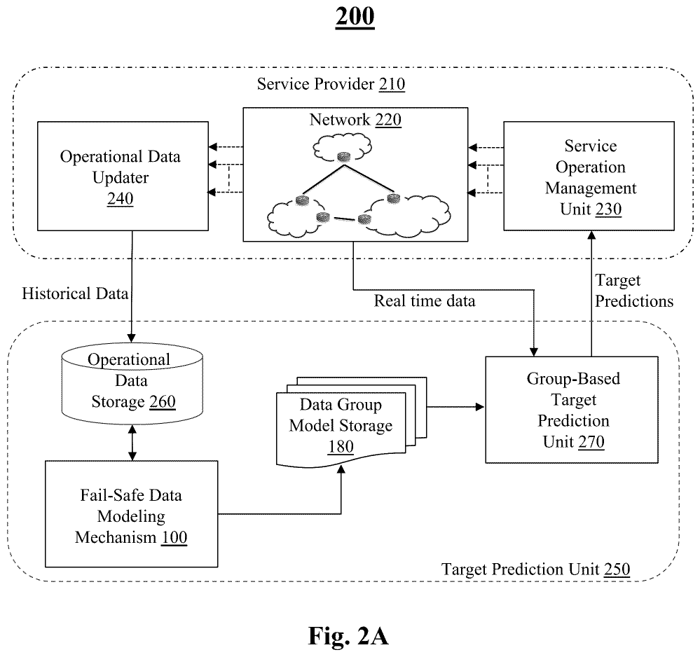

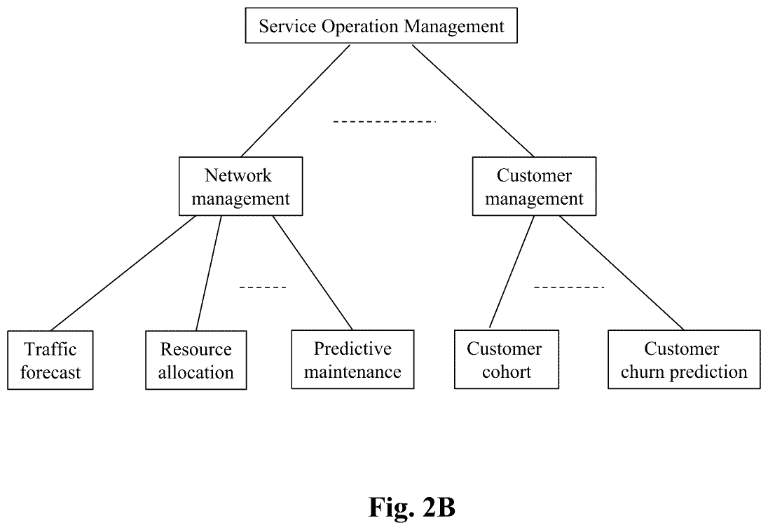

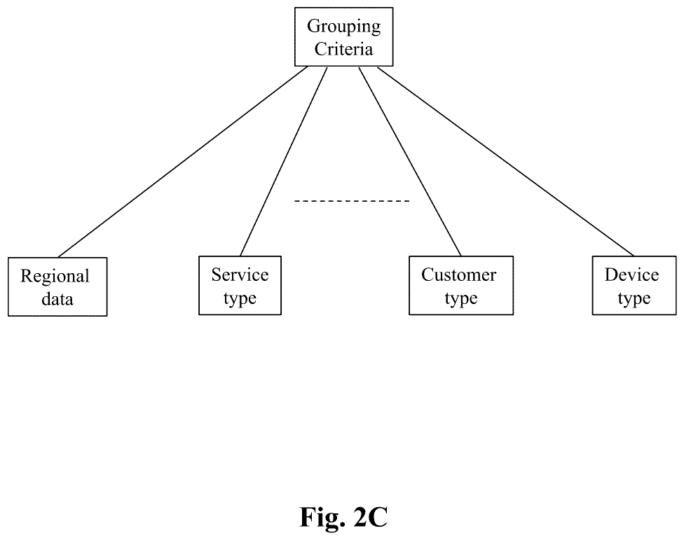

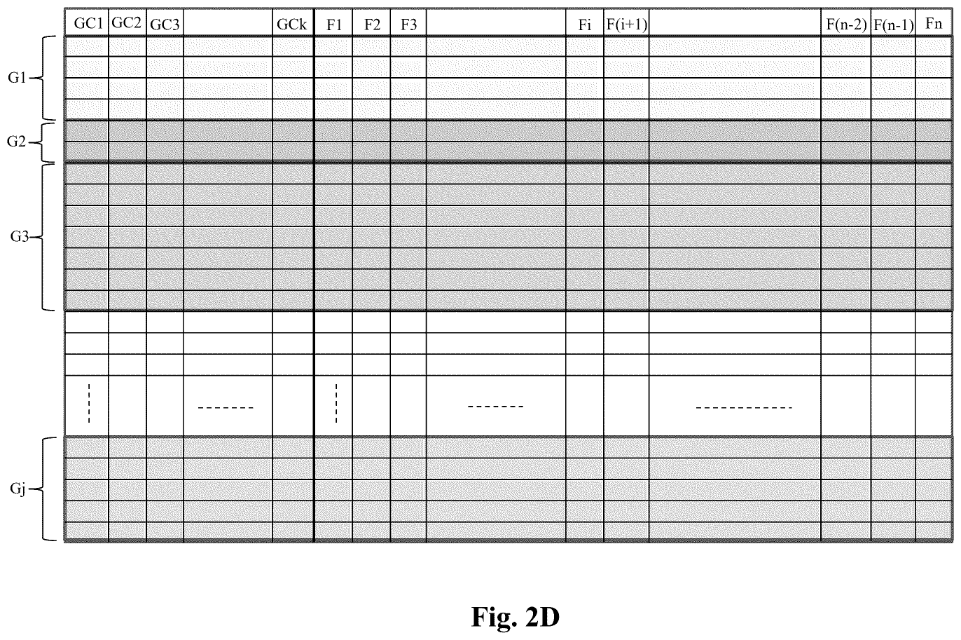

FIG. 2A depicts an exemplary application environment 200 for network operation management that deploys the fail-safe distributed modeling framework, in accordance with an embodiment of the present teaching. In this illustration, the application environment 200 includes a service provider 210 and a target prediction unit 250. In some embodiments, the service provider 210 may correspond to a wireless communication service provider which may include a network 220, through which wireless services are delivered to customers, a service operation management unit 230 for managing different aspects of the network to ensure performance, and an operational data updater 240 for providing dynamic historical data for distributed data modeling to create data group models in storage 180 used to predict respective targets.

The historical data is provided to a target prediction unit 250, which is to predict different target metrics using distributed models obtained via fail-safe approach as discussed herein. The service operation management unit 230 may operate to manage different network components to ensure the performance with respect to some specified targets, e.g., transmission speed, bandwidth capacity, etc. Based on the specified targets, metrics associated with such targets may be predicted based on real-time network operational data using models trained using the historical data. As seen in this application environment 200, the historical data received from the operational data updater 240 and archived in operational data storage 260 may be used by the fail-safe data modeling unit 100 to derive data group models in storage 180 via the fail-safe modeling approach according to the present teaching so that the data group models in storage 180 may be used by a group-based target prediction unit 270 to predict different operational metrics associated with specified management targets. The predicted target metrics are then provided to the service operation management unit 230, which manages the network 220 according to the received predictions.

FIG. 2B illustrates exemplary types of service operation management tasks that may be managed using data group models obtained via fail-safe distributed modeling, according to an embodiment of the present teaching. For example, the service provider 210 may desire to manage the service according to both the aspect related to network performance and the aspect of customer satisfaction. With respect to management of the network performance, the targets may be directed to traffic forecast, resource allocation, . . . , and predictive maintenance associated with, e.g., each of the towers in each service regions. With respect to effort directed to customer satisfaction, the targeted aspects to be managed may include custom cohorts (e.g., for detecting preferences with respect to different user cohorts) and custom churn predictions so that preemptive measures may be adopted to prevent churns.

FIG. 2C illustrates exemplary grouping criteria used in the exemplary network management application as shown in FIG. 2A for creating different data groups for distributed modeling. In the context of network management of different targets as illustrated in FIG. 2B, historical data collected from prior network operations may be grouped according to, e.g., service regions (e.g., east coast and west coast of the United States), service types (e.g., basic phone service, phone plus on-demand entertainment services, etc.), customer types (e.g., low and high end customers), device types (iOS or Android supported devices), service channel, installment type, fulfillment type, etc. Such criteria may be used individually or in combination to dissect data into different groups, each of which may represent a data group associated with certain characteristics, which may be modeled in accordance with the present teaching.

As discussed herein, in addition to grouping criteria that may be used to dissect data to create different collections each of which may exhibit certain characteristics (e.g., a data group obtained via service region and service type), data collected may also represent certain features associated with the operational states of each data sample in each group. For instance, data collected from the operation of a wireless tower may include the service region it is located, the service type it provides, and some operational status information at the point of data collection such as its transmission speed, its storage usage level, its bandwidth capacity, and the number of users in the scope of the tower, etc. While some information collected (e.g., the service region and service type) may be used to determined how to group different pieces of data, other information collected (e.g., transmission speed, bandwidth capacity, etc.) may characterize the tower in terms of its performance.

FIG. 2D shows an exemplary data organization in which data groups are established based on grouping criteria and data in each group is characterized by other features. As shown, each row represents a data sample as collected (e.g., data collected at a particular point of time from a tower in a wireless network) and it includes a plurality of features, some of which are associated with grouping criteria, e.g., GC1, GC2, . . . , GCk, and some are features F1, F2, . . . , Fn, that may be indicative of the current operational states. Based on the values of the grouping criteria associated with different data samples, data is grouped to form different data groups, e.g., data groups G1, G2, G3, . . . , Gj. As also illustrated, each data group includes multiple data samples, each of which is characterized by the plurality of features F1, . . . , Fn.

Based on the data organization as shown in FIG. 2D, each data group is used by the data group modeling unit 160 to train a model for the data group to generate a data group model. If the modeling performed by the data group modeling unit 160 is successful, the generated data group model is stored in the data group models in storage 180. If the modeling is not successful, then the data group modeling unit 160 may signal the alternative modeling unit 170 so that the approximation-based modeling scheme may be used to derive an alternative model for the data group according to the present teaching.

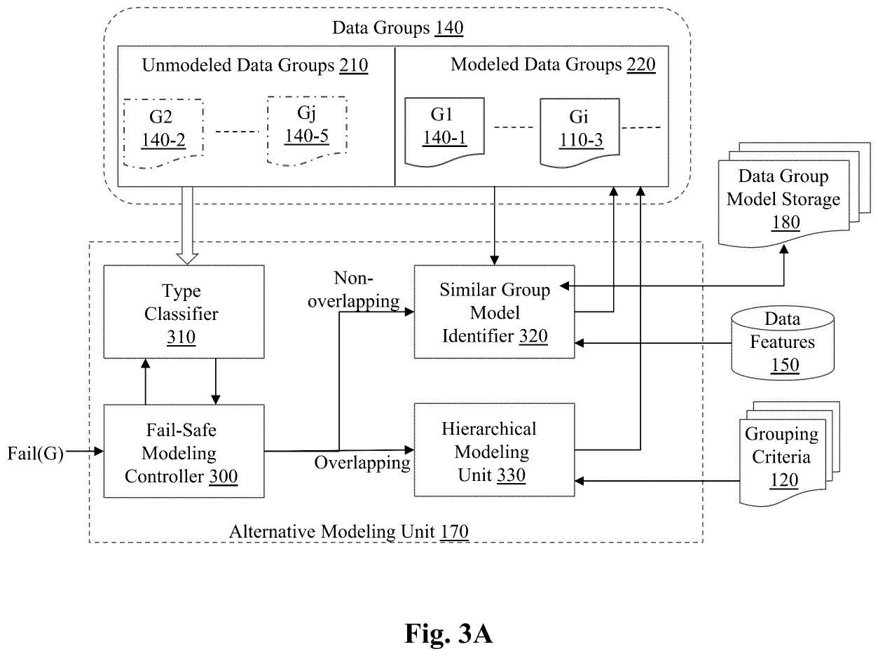

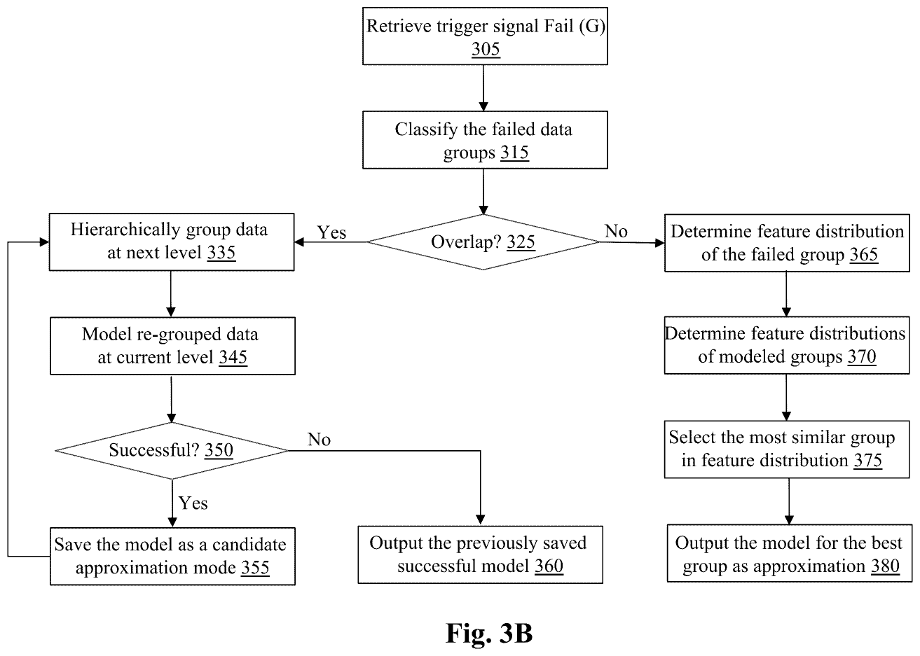

FIG. 3A depicts an exemplary high-level system diagram of the alternative modeling unit 170, in accordance with an embodiment of the present teaching. In this illustrated embodiment, the alternative modeling unit 170 comprises a fail-safe modeling controller 300, a type classifier 310, a similar group model identifier 320, and a hierarchical modeling unit 330. The fail-safe modeling controller 300 is provided to control the operation of the alternative modeling unit 170 upon receiving a signal indicating that there are some data groups in 140 that failed the initial modeling. The type classifier 310 is provided to classify each of the failed data groups as either overlapping or non-overlapping. Depending on the classification, the fail-safe modeling controller 300 invokes either the hierarchical modeling unit 330 (for an overlapping data group) or the similar group model identifier 320. The hierarchical modeling unit 330 is provided for carrying out the bottom-up hierarchical approximation to obtain an approximated model for the failed data group. The similar group model identifier 320 is provided for identifying a successfully modeled data group with its feature distribution best matched with that of the failed data group so that the model for the successfully modeled data group is used to obtain an approximation model for the failed data group.

FIG. 3B is a flowchart of an exemplary process of the alternative modeling unit 170, in accordance with an embodiment of the present teaching. When a signal (from the data group modeling unit 160) indicative of a failed data group is received at 305, the type classifier 310 classifies, at 315, the failed group as either overlapping or non-overlapping. If the failed data group is overlapping, determined at 325, the hierarchical modeling unit 330 is invoked and it groups, at 335, data at the next level (in the first iteration it is the bottom level) of the hierarchy (i.e., using a combination of grouping criteria features) to create a re-grouped data and then models, at 345, the re-grouped data. If the modeling for the re-grouped data is successful, determined at 350, the derive model for the re-grouped data is saved, at 355, as a candidate approximation model for the failed data group. The process then proceeds to step 335 carry the operation at the next hierarchical level to generate the re-grouped data at the next level and modeling thereof. If the modeling for the re-grouped data is not successful, determined at 350, then the previously saved candidate approximation model for the failed data group is output, at 360, as the alternative approximation model for the failed group.

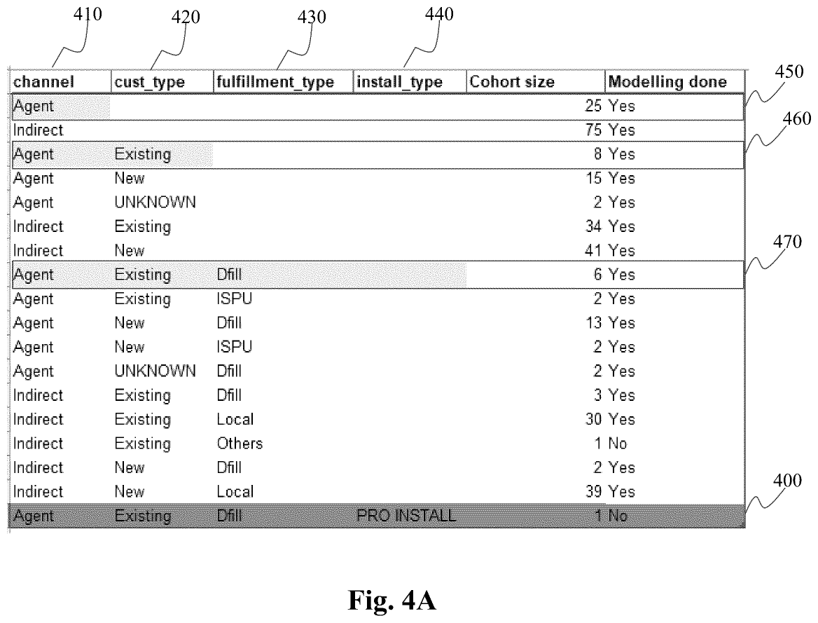

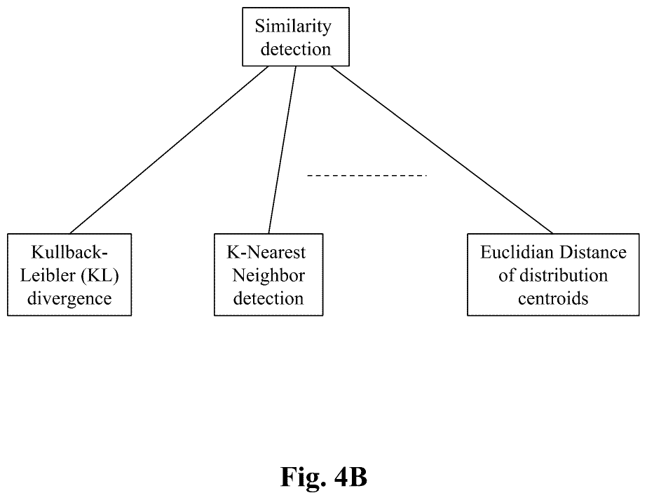

FIG. 4A illustrates an example of a hierarchy of data groups relevant to a failed overlapping data group to identify an alternative data grouping to derive an approximate model for the failed data group, in accordance with an embodiment of the present teaching. In this illustrated example, data group 400 failed the modeling because there is only one data sample therein due to the use of a combination of 4 grouping criteria, including channel 410, customer type 420, fulfillment type 430, and installment type 440. Due to the insufficient group size, the modeling of data group 400 failed. Because data group 400 is an overlapping group, i.e., it shares grouping criteria with other groups, the bottom-up hierarchical modeling is performed. At the initial bottom level, only one grouping criterion is used, e.g., using channel 410 as the grouping criterion and it yielded a re-grouped data group 450 with a cohort size of 25, i.e., there are 25 data samples that have the same value on this grouping criterion 400. Based on this data group of size 25, the modeling is performed and is successful. Then the hierarchical process proceeds to the second level, using a combination of two grouping criteria, e.g., channel 400 and customer type 420. This re-grouped cohort 460 has a group size of 8, which may still yield successful modeling. At the third level, a combination of three grouping criteria is used with channel 400, customer type 420, and fulfillment type 430 that yields a data group 470 of size 6. If modeling at this level on a cohort 470 of size 6 fails, then the model successfully obtained for a cohort at the previous level (i.e., using two grouping criteria 400 and 410) may be used as the approximate model for the failed data group 400.

If the failed data group is classified as non-overlapping, determined at 325, the similar group model identifier 320 is invoked to determine, at 365, the feature distribution of the failed data group and determine, at 370, the feature distribution(s) of all the successfully modeled data groups. The similarity between the feature distribution of the failed data group and that of each of the successfully modeled data group(s) may be respectively computed and used to select, at 375, a successful data group whose feature distribution is the most similar to that of the failed data group. The model obtained for the selected successful data group is then output, at 380, as the approximate model for the failed data group.

FIG. 4B shows exemplary means for identifying a data group with a similar feature distribution to obtain an approximate model for a failed non-overlapping data group, in accordance with an embodiment of the present teaching. As illustrated herein, to measure similarity between two feature distributions, any method, or metrics, either currently available or future developed, may be used to achieve that. For example, the KL divergence test may be used. In addition, given two distributions, the K-nearest neighbor method may be used to identify nearby neighbors in the feature space and one that is the closest may be selected. In some situations, a centroid may be determined with respect to a distribution and used to represent the distribution. In this case, the similarity between two distributions may be estimated based on the distance between the two centroids of the distributions.

As disclosed herein, distributed modeling of different data groups with coverage may be achieved via the fail-safe approach as discussed herein to ensure that data groups that failed in modeling using a conventional modeling process can still be modeled via approximation by systematically deriving models for such data groups according to the present teaching.

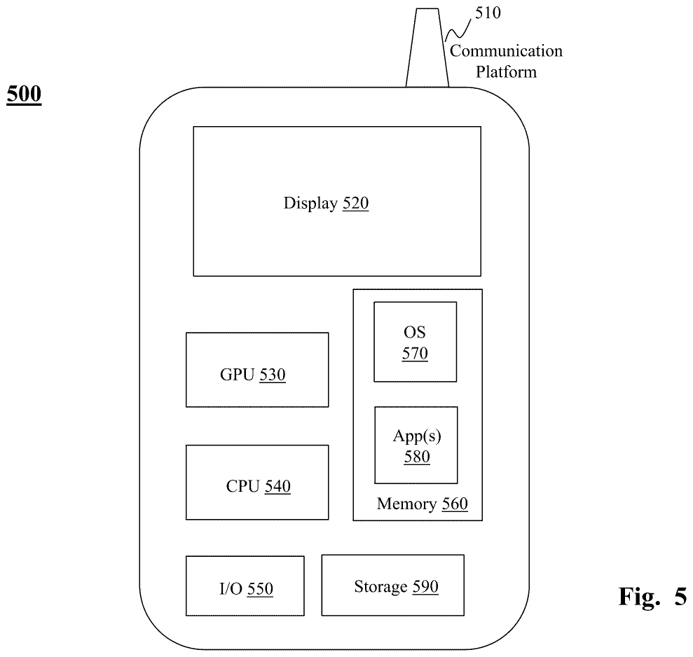

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or a mobile computational unit in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.) and one or more applications 580 may be loaded into memory 560 from storage 590 to be executed by the CPU 540. The applications 580 may include a user interface or any other suitable mobile apps for information exchange, analytics, and management according to the present teaching on, at least partially, the mobile device 500. User interactions, if any, may be achieved via the I/O devices 550 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

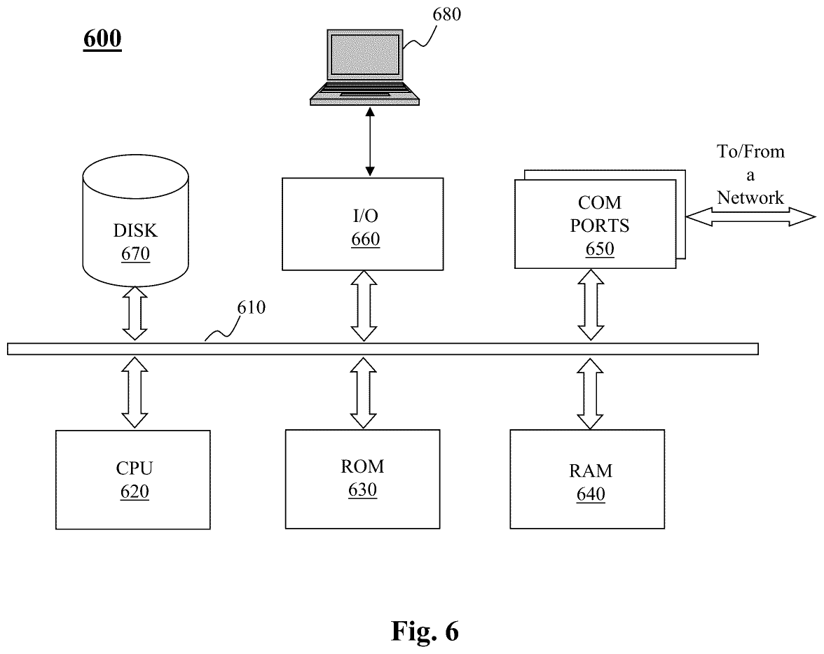

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information processing and analytical method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving historical data characterizing previous operational states of a network;
creating multiple data groups based on the historical data in accordance with grouping criteria specified in connection with management of the network;
extracting features of data samples in each of the multiple data groups;
with respect to each of the multiple data groups,
modeling the data group via machine learning based on training data created using historical data and the features thereof associated with the data group,
if the modeling is successful, archiving the model for the data group,
if the modeling is not successful, obtaining an approximate model for the data group by,
classifying the data group as either overlapping or non-overlapping,
identifying, if the data group is non-overlapping, a learned model of a selected previously successfully modeled data group as the approximation model for the data group,
creating, if the data group is overlapping, the approximation model for the data group via bottom-up hierarchical approximation;
receiving real time data from the network representing a current operational state of the network; and
predicting, using respective models for the multiple data groups, target metrics defined based on needs associated with the management of the network based on the real time data, wherein the predicted target metrics are utilized in managing the network to ensure performance.

2. The method of claim 1, wherein the grouping criteria used to group the historical data include information associated with data samples in the historical group indicating:
a region;
a service type;
a device type;
a customer type;
a channel;
a fulfillment type;
an installation type; and
any combination thereof.

3. The method of claim 1, wherein the data group classified as overlapping share one or more grouping criteria with other data groups.

4. The method of claim 1, wherein the identifying the approximation model for the data group that is non-overlapping comprises:
identifying previously successfully modeled data groups;
determining a respective distribution of features associated with data samples in each of the previously successfully modeled data groups;
computing an instant distribution of the data group currently being modeled; and
obtaining the selected previously successfully modeled data group based on pairs of the instant distribution of the data group and one of the respective distributions of features associated with each of the previously successfully modeled data groups.

5. The method of claim 4, further comprising:
computing a metric with respect to each of the pairs to represent similarity between the instant distribution of the data group and a respective distribution of a corresponding previously successfully modeled data group;
determining one of the pairs as the most similar pair to obtain therefrom the selected previously successfully modeled data group;
retrieving the learned model for the selected previously successfully modeled data group; and
outputting the retrieved learned model as the approximate model for the data group.

6. The method of claim 1, wherein the creating the approximation model via bottom-up hierarchical approximation comprises:
initializing the hierarchical approximation at a bottom level by determining a current re-grouping set of criteria selected from the grouping criteria;
obtaining a re-grouped data group from the historical data using the current re-grouping set of criteria;
re-modeling the re-grouped data group via machine learning based on training data created using historical data and the features thereof associated with the re-grouped data group;
if the re-modeling the re-grouped data group is successful, archiving the model from re-modeling as a candidate approximate model for the data group;
updating the current re-grouping set of criteria for re-grouping at a next level of the hierarchical approximation; and
repeating the steps of obtaining, modeling, archiving, and updating until the re-modeling is not successful.

7. The method of claim 6, further comprising:
when the re-modeling of the re-grouped data group is not successful,
retrieving a last archived candidate approximate model, and
outputting the retrieved last archived candidate approximate model as the approximate model for the data group.

8. A machine-readable and non-transitory medium having information recorded thereon, wherein the information, when read by the machine, causes the machine to perform the following steps:
receiving historical data characterizing previous operational states of a network;
creating multiple data groups based on the historical data in accordance with grouping criteria specified in connection with management of the network;
extracting features of data samples in each of the multiple data groups;
with respect to each of the multiple data groups,
modeling the data group via machine learning based on training data created using historical data and the features thereof associated with the data group,
if the modeling is successful, archiving the model for the data group,
if the modeling is not successful, obtaining an approximate model for the data group by,
classifying the data group as either overlapping or non-overlapping,
identifying, if the data group is non-overlapping, a learned model of a selected previously successfully modeled data group as the approximation model for the data group,
creating, if the data group is overlapping, the approximation model for the data group via bottom-up hierarchical approximation;
receiving real time data from the network representing a current operational state of the network; and
predicting, using respective models for the multiple data groups, target metrics defined based on needs associated with the management of the network based on the real time data, wherein the predicted target metrics are utilized in managing the network to ensure performance.

9. The medium of claim 8, wherein the grouping criteria used to group the historical data include information associated with data samples in the historical group indicating:
a region;
a service type;
a device type;
a customer type;
a channel;
a fulfillment type;
an installation type; and
any combination thereof.

10. The medium of claim 8, wherein the data group classified as overlapping share one or more grouping criteria with other data groups.

11. The medium of claim 8, wherein the identifying the approximation model for the data group that is non-overlapping comprises:
identifying previously successfully modeled data groups;
determining a respective distribution of features associated with data samples in each of the previously successfully modeled data groups;
computing an instant distribution of the data group currently being modeled; and
obtaining the selected previously successfully modeled data group based on pairs of the instant distribution of the data group and one of the respective distributions of features associated with each of the previously successfully modeled data groups.

12. The medium of claim 11, wherein the information, when read by the machine, further causes the machine to perform the following steps:
computing a metric with respect to each of the pairs to represent similarity between the instant distribution of the data group and a respective distribution of a corresponding previously successfully modeled data group;
determining one of the pairs as the most similar pair to obtain therefrom the selected previously successfully modeled data group;
retrieving the learned model for the selected previously successfully modeled data group; and
outputting the retrieved learned model as the approximate model for the data group.

13. The medium of claim 8, wherein the creating the approximation model via bottom-up hierarchical approximation comprises:
initializing the hierarchical approximation at a bottom level by determining a current re-grouping set of criteria selected from the grouping criteria;
obtaining a re-grouped data group from the historical data using the current re-grouping set of criteria;
re-modeling the re-grouped data group via machine learning based on training data created using historical data and the features thereof associated with the re-grouped data group;
if the re-modeling the re-grouped data group is successful, archiving the model from re-modeling as a candidate approximate model for the data group;
updating the current re-grouping set of criteria for re-grouping at a next level of the hierarchical approximation; and
repeating the steps of obtaining, modeling, archiving, and updating until the re-modeling is not successful.

14. The medium of claim 13, wherein the information, when read by the machine, further causes the machine to perform the following steps:
when the re-modeling of the re-grouped data group is not successful,
retrieving a last archived candidate approximate model, and
outputting the retrieved last archived candidate approximate model as the approximate model for the data group.

15. A system, comprising:
a fail-safe data modeling mechanism implemented by a processor and configured for:
receiving historical data characterizing previous operational states of a network,
creating multiple data groups based on the historical data in accordance with grouping criteria specified in connection with management of the network,
extracting features of data samples in each of the multiple data groups,
with respect to each of the multiple data groups,
modeling the data group via machine learning based on training data created using historical data and the features thereof associated with the data group,
if the modeling is successful, archiving the model for the data group,
if the modeling is not successful, obtaining an approximate model for the data group by,
classifying the data group as either overlapping or non-overlapping,
identifying, if the data group is non-overlapping, a learned model of a selected previously successfully modeled data group as the approximation model for the data group,
creating, if the data group is overlapping, the approximation model for the data group via bottom-up hierarchical approximation; and
a group-based target prediction unit implemented by a processor and configured for
receiving real time data from the network representing a current operational state of the network, and
predicting, using respective models for the multiple data groups, target metrics defined based on needs associated with the management of the network based on the real time data, wherein the predicted target metrics are utilized in managing the network to ensure performance.

16. The system of claim 15, wherein
the grouping criteria used to group the historical data include information associated with data samples in the historical group indicating:
a region,
a service type,
a device type,
a customer type,
a channel,
a fulfillment type,
an installation type, and
any combination thereof; and
the data group classified as overlapping share one or more grouping criteria with other data groups.

17. The system of claim 15, wherein the identifying the approximation model for the data group that is non-overlapping comprises:
identifying previously successfully modeled data groups;
determining a respective distribution of features associated with data samples in each of the previously successfully modeled data groups;
computing an instant distribution of the data group currently being modeled; and
obtaining the selected previously successfully modeled data group based on pairs of the instant distribution of the data group and one of the respective distributions of features associated with each of the previously successfully modeled data groups.

18. The system of claim 17, further comprising:
computing a metric with respect to each of the pairs to represent similarity between the instant distribution of the data group and a respective distribution of a corresponding previously successfully modeled data group;
determining one of the pairs as the most similar pair to obtain therefrom the selected previously successfully modeled data group;
retrieving the learned model for the selected previously successfully modeled data group; and
outputting the retrieved learned model as the approximate model for the data group.

19. The system of claim 15, wherein the creating the approximation model via bottom-up hierarchical approximation comprises:
initializing the hierarchical approximation at a bottom level by determining a current re-grouping set of criteria selected from the grouping criteria;
obtaining a re-grouped data group from the historical data using the current re-grouping set of criteria;
re-modeling the re-grouped data group via machine learning based on training data created using historical data and the features thereof associated with the re-grouped data group;
if the re-modeling the re-grouped data group is successful, archiving the model from re-modeling as a candidate approximate model for the data group;
updating the current re-grouping set of criteria for re-grouping at a next level of the hierarchical approximation; and
repeating the steps of obtaining, modeling, archiving, and updating until the re-modeling is not successful.

20. The system of claim 19, further comprising:
when the re-modeling of the re-grouped data group is not successful,
retrieving a last archived candidate approximate model, and
outputting the retrieved last archived candidate approximate model as the approximate model for the data group.
